(19) United States
(12) Patent Application Publication
(10) Pub. No.: US 2003/0024324 A1
(43) Pub. Date: Feb. 6, 2003

(54) Flowmeter sensor

(76) Inventors: Klaus Hanl, Eschwege (DE); Wolfgang Weber, Eschwege (DE); Jurgen Stassfurth, Lohfelden (DE); Matthias Huppe, Sohrewald (DE)

Correspondence Address: McGLEW AND TUTTLE, P.C., SCARBOROUGH STATION, SCARBOROUGH, NY, 10510-0827, US

(21) Appl. No.: 10/202,344

(22) Filed: Jul. 24, 2002

(30) Foreign Application Priority Data
Aug. 4, 2001 (DE) 101 38 488.2

(51) Int. Cl. G01F 15/00

(52) U.S. Cl. 73/861.77

(57) ABSTRACT

A cartridge (3) carrying an impeller (4) is inserted into a flowmeter sensor (1). The water pressure and shape tolerances as well as forces and bending moments acting on the system from the outside shall not affect the rotary behavior of the impeller (4). The outer surface (10) of the cartridge (3) is spaced apart from the inner surface (11) of the water space (20). A flange (14) is provided to seal the cartridge (3) against the water space (20). The cartridge (3) is supported linearly or in a punctiform manner in a guide area (32) of the inner surface (11).

### FIELD OF THE INVENTION

The present invention pertains to a flowmeter sensor for determining the flow of a medium, especially liquids, with an impeller installed in a cartridge, wherein the cartridge is replaceably introduced into a water space of a housing or apparatus, and the water space has connections to lines carrying medium.

### BACKGROUND OF THE INVENTION

A flowmeter sensor has been known from U.S. Pat. No. 5,721,383. An impeller is arranged there in a water-carrying line such that it is moved radially by the medium flowing through. A sensor measures the rotary movement of the impeller and transmits the data determined to an evaluating and transmission means. This contains a transmitter, via which it transmits the flow data determined to a receiver in a wireless manner.

A device for determining the flow of a flowing medium is shown, furthermore, in DE 39 40 280 C2. A housing of conical and tubular design is equipped with a stationarily arranged soft magnetic core as well as with primary and secondary coils. The change in position is determined by magnetic path detection by means of a dynamic pressure body at flows of different intensities. The conicity of the housing is used to vary the dynamic pressure as a function of the position of the dynamic pressure body, as a result of which the flow can be measured.

DE 41 11 001 A1 describes a device for determining the velocity of flow of a medium, in which an impeller, whose blades are magnetic, is arranged in the axial direction, as a result of which voltage impulses are induced in a coil arranged in the area of the tube wall by the rotary movement of the impeller.

A flow-measuring system, in which a flowmeter sensor, which transmits signals to an electronic unit located in a dry space adjoining the water-carrying space due to its rotary movement during the flow of water, is arranged in a water-carrying space, is known from the firm of Wellspring Wireless Utility Services, which can be seen at the homepage address “http://www.wellspringwireless.com.” An antenna transmits the data determined, which were processed by an electronic unit, to a receiver.

A water flowmeter with a rotary body, which has ray-shaped pins, is located in the flow cross section of a housing and swirls the flow of water only slightly, has been known from DE 40 29 780 C2. The water flowmeter is arranged in an instantaneous water heater.

The prior-art devices have flowmeter sensors in which the water pressure and shape tolerances of the wall of the water flowmeter affect especially the mechanical properties of the system. The change in the shape of the components, which results from the water pressure on the devices, leads to internal stresses as well as geometric deviations, which may lead, e.g., to a change in the bearing position and thus may give rise to increased friction in the bearings of the impeller and consequently to a lack of reproducibility of the measurement results. Deviations in the shape of the wall, which occur especially in interlaced and asymmetric housings, also affect the cartridge, in which the impeller is arranged, and deform same.

DE 44 45 976 A1 describes a flow meter, in which the impeller is said to be able to be removed and installed in a simple manner at its measuring insert. The measuring insert is said to cause the lowest possible pressure losses. Part of the flowing medium flows past the measuring insert on the outside. Errors in measurement develop due to changes in the pressure conditions and in the case of different water flows.

A Woltmann impeller type meter, whose impeller is met by the flow radially, has been known from DE 39 09 722 A1. There are high pressure losses as a consequence of the deflection of the water flow.

A liquid meter is described in DE 19 48 622 B2. The measuring insert, which can be pushed in, protrudes freely into the counter housing and is guided in a hole of the housing by means of a holding ring.

DE 42 18 812 A1 describes an impeller of a liquid meter, which is torn in a special manner.

A meter for liquids has been known from DE 39 36 712 A1. The cartridge is fitted into a tube of the meter housing and is fixed there. The above-mentioned disturbances in the measurement results may occur in practice.

A liquid meter with a chamber jacket injection-molded in one piece from a plastic, a chamber cover and a housing top part has been known from DE 199 63 076 C2. The chamber jacket is located at a spaced location from the housing wall by forming an intermediate space.

### SUMMARY OF THE INVENTION

The object of the present invention is to find a device for measuring the flow of a medium, which can be inserted into water spaces and in which the water pressure of the water feed system as well as shape tolerances and changes in shape of the water space and of the cartridge do not affect the rotary behavior of the flowmeter sensor proper.

According to the invention, a flowmeter sensor for determining the flow of a medium, especially liquids, is provided with an impeller installed in a cartridge. The cartridge is replaceably inserted into a water space of a housing or apparatus and the water space has connections to lines carrying the medium. The outer surface of the cartridge is spaced apart from the inner surface of the water space by forming a narrow space. To seal the cartridge, the cartridge has a flange mounted in the expansion of the water space. The outer surface of the cartridge is subsequently supported at the flange by the guide surface of the inner surface of the water space. The guide area is short compared with the length of the cartridge. Linear or punctiform support zones are provided at the inner surface in the guide area. The intermediate zones located between the support zones are open toward the narrow space.

Changes in the shape of a flowmeter sensor are avoided by the pressure forces of the static pressure being absorbed by the wall of a water space. The cartridge holding the flow sensor proper is inserted into the water space such that the outer surfaces of the cartridge and the inner surfaces of the wall of the water space are spaced apart from one another. The resulting gap or space is thus filled by water to which static pressure is admitted. Since the wall of the cartridge is uncoupled from pressure forces of the medium flowing through, it may be made as a thin wall. The wall of the water space undergoes deformation during changes in the water pressure, but the wall of the cartridge does not. A change in the shape of the cartridge does not occur under any circumstances, because the pressure of the water is admitted to it on both sides. Due to the gap or space, dimensional tolerances of the wall of the water space and of the cartridge cannot affect the rotary behavior of the impeller.

It is guaranteed by a specially designed guide area that the cartridge is reliably guided there, on the one hand, and, on the other hand, the pressure of the water is admitted to the wall of the cartridge there as well. The cartridge is thus arranged in the water space freely or floatingly. It is consequently free in relation to the wall of the water space, as a result of which dimensional tolerances that are inherently present or arise during the operation, changes in the pressure conditions and forces acting on the system from the outside as well as bending moments do not practically affect the measurement result.

Forces and/or bending moments may be transmitted to the housing of the measuring system by the tubes or lines connected to the measuring system. The housing is also deformed due to this effect in the flow area of the cartridge, but the effect on the cartridge remains so weak that deviations in the dimensional accuracy are avoided.

A flange with a radial guide of the cartridge preferably has a flexible sealing lip, which is in contact with the wall of an expansion of the water space. This contact area between the sealing lip and the wall is of a conical design. The conical surface of the flange is now in contact with the conical surface of the wall, and the forces that are needed for the sealing are applied by the deformation of the sealing lip and friction between the surfaces of the flowmeter sensor and the water-carrying system. Water flows past the cartridge that cause errors of measurement are thus avoided. The pressure effects are further minimized by the inner pressure loss at the impeller due to the flange being positioned approximately on the middle of the cylindrical water space. To position the cartridge in the water space, spacers in the form of warts or locking hooks, distributed in a radial pattern, are arranged on the outside of the cartridge. These are in contact with the inner surface or recesses of the inner surface of the wall. One locking hook is sufficient for positioning, but a radial distribution of locking hooks or warts on the surface is advantageous, as a result of which tilting moments of the cartridge can also be absorbed. Furthermore, the locking hooks are used for securing during transportation. It is achieved that the cartridges are fixed in the housing in a positive-locking manner.

The cartridge is transparent to make possible the simple checking of the function of the flowmeter sensor, as a result of which it can be optically determined whether the impeller is rotating. The start-up behavior can be checked, e.g., by checking at the beginning of the flow of water when the impeller begins to rotate.

Two bearing blocks, between which the impeller is mounted rotatably, are contained in the cartridge. The bearing bushes inserted into the bearing blocks preferably consist of teflon and the axes of the impeller of polyamide, as a result of which very good dry and wet running properties are achieved. The bearing bushes may have any desired design on their front side, whereas the axis of the impeller is flat on the front side. To further optimize the frictional behavior, the teflon bearing has a graphite content of 15%.

The frictional forces, especially axial friction, can be compensated by adjusting the weight of the impeller. There is an effective weight of the impeller due to the selection of materials of a density deviating from the density of the basic material of the impeller. In the case of an advantageous coordination, the weight is precisely equal to the axial force caused by the flowing medium, as a result of which the acting axial forces are compensated. It is necessary for this to arrange the flow-measuring area extensively in a vertical position.

To make it possible to detect the rotary movement by means of a sensor, the impeller is made entirely or partially of magnetic materials. Thus, magnetizable components are added to the plastic of which it is manufactured. To detect the pulses generated by the impeller accurately and in a power-saving manner, a sensor, e.g., a Hall sensor, is associated with the impeller, separated from the walls of the water space and of the cartridge. Due to the thin wall of the cartridge, equaling, e.g., 1 mm, the pulse-generating impeller and the pulse-detecting sensor are located at closely spaced locations.

A dry space, which is separated from the water space but adjoins same, is arranged at the flowmeter sensor to accommodate an electronic unit with a transmitting means and a power supply unit. For sealing, this dry space is provided with a seal either on a cover or on the edge surface of the housing, is bonded or welded by ultrasound to the housing. This seal is advantageously manufactured according to a two-component injection molding technique. For fixing and positioning a sensor connected to the electronic unit, the cover or the housing of the dry space has a locking or spring device. This may also be manufactured according to the two-component injection molding technique or from the material of the cover. The spring device is advantageously designed in the form of a membrane.

An antenna connected to the electronic unit is arranged in the dry space, without a separate space being formed herefor. The arrangement of the antenna is thus not visible from the outside. A battery is used for the power supply and is likewise arranged in the dry space.

The flowmeter sensor can be outfitted as a functional unit as a water meter or as a volume flow detection device, e.g., in an instantaneous water heater. The cartridge can be mounted as an insert in any apparatus or device in which a fluid flow is to be measured.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a sectional view of a flowmeter sensor with axial impeller in a water space as well as in a dry space;

FIG. 2 is sectional view of a flowmeter sensor with a gap;

FIG. 3 is an enlarged sectional view of the flange area of the cartridge;

FIG. 4 is an enlarged sectional view of the dry space with the spring membrane and the electronic board;

FIG. 5 is sectional view of the cartridge with the bearing block;

FIG. 6 is a sectional view of the cartridge with webs, bearing block and spacer along line VI-VI according to FIG. 5;

FIG. 7 is an enlarged sectional view of the area of the cartridge with the bearing block and the spacer;

FIG. 8 is an enlarged sectional view of the area of the cartridge with webs and pins;

FIG. 9 is an enlarged sectional view of the flange of the cartridge with shoulder, sealing lip and conical surface;

FIG. 10 is sectional view along line X-X in FIG. 2;

FIG. 11 is a partial sectional view along line X-X in FIG. 2 in the gap area, enlarged compared with FIG. 2; and

FIG. 12 is a partial sectional view along line XII-XII in FIG. 2 in the guide area, enlarged compared with FIG. 2.

### DESCRIPTION OF THE PREFERRED EMBODIMENTS

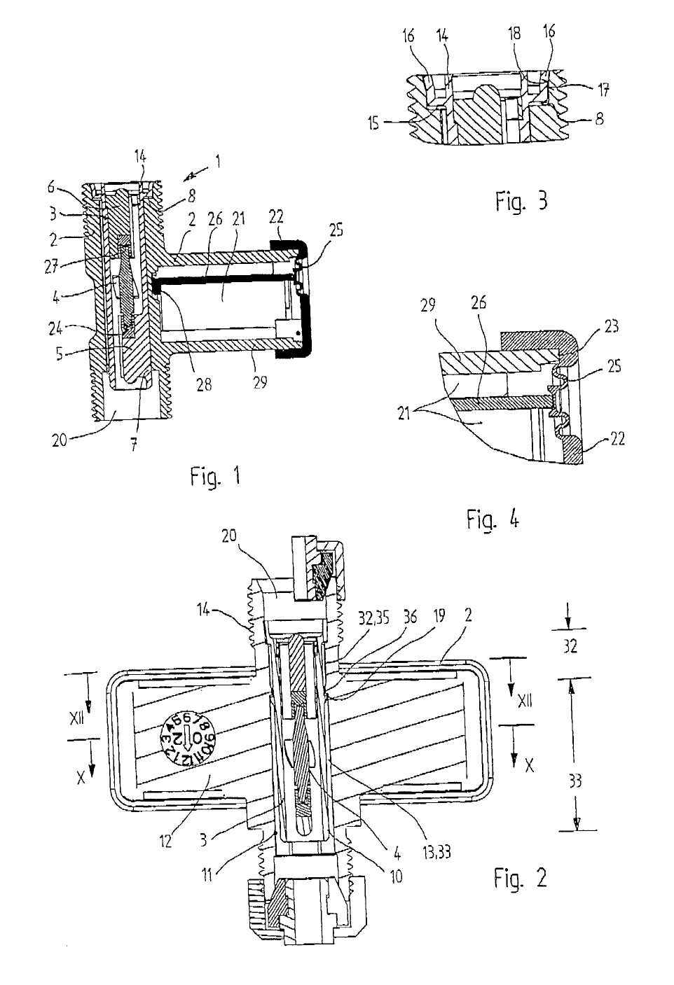

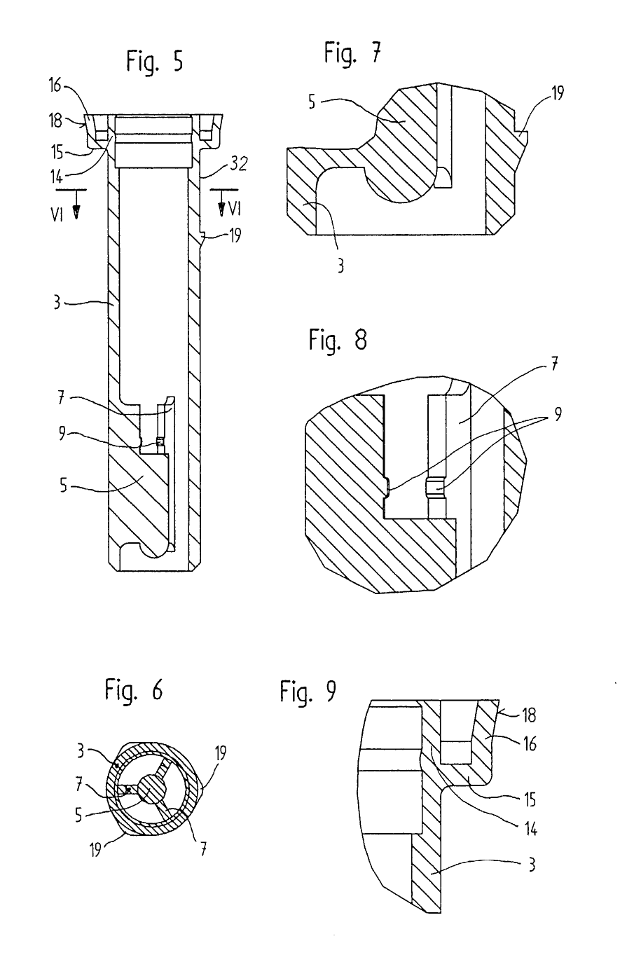

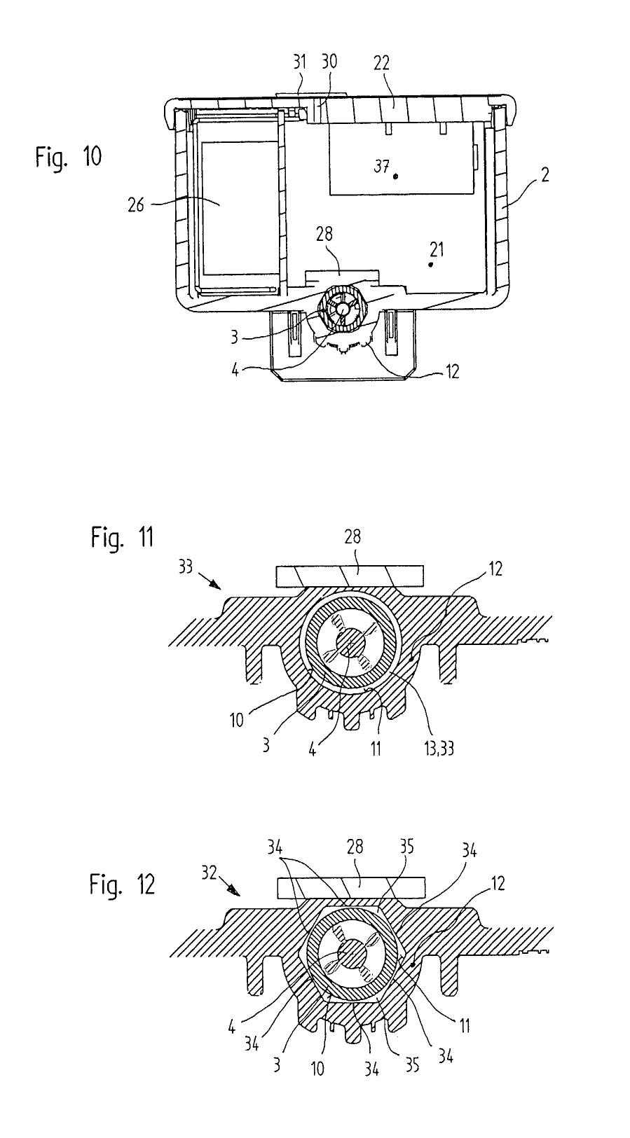

Referring to the drawings in particular, the flowmeter sensor 1 shown in FIG. 1 is formed by a housing 2 and a cartridge 3 with the impeller 4. The impeller 4 is held rotatably in a first bearing block 6 and in a second bearing block 5. In an advantageous embodiment, the first bearing block 6 is made rigidly in one piece with the cartridge 3 on the inside via webs 7. The second bearing block 5 is inserted replaceably into the cartridge 3. Webs are likewise used here to axially fix this bearing block 5 in the cartridge radially and axially. Bearings 24, which have a crowned bearing surface 27 to minimize friction, are inserted into the bearing blocks 5 and 6. For the axial fixation of the bearings 24, the webs 7 have, furthermore, pins 9, which snap into clearances in the bearing 24, which are not shown.

The outer surface 10 of the cartridge 3 is located at a spaced location from the inner surface 11 of a wall 12 of the housing 2, as a result of which a space or gap 13 is formed between the wall 12 and the cartridge 3. The flange 14 has a shoulder 15 and a flexible sealing lip 16 with a conical surface 18, which is in contact in the expansion 8 with a conical surface 17 of the water space 20. The cartridge 3 can be fixed and positioned to a certain extent due to frictional forces between the conical surfaces 18 and 17.

The forces needed for the sealing can also be exerted on the sealing lip 16 by pressing forces which act on the water pipe system after the mounting of the device. Spacers 19 arranged at the cartridge 3 additionally space apart and fix the cartridge 3 at a wall 12.

A dry space 21, separated by a wall 12, adjoins the water space 20. The dry space 21 is closed by a cover 22. The edge surfaces 23 of the dry space 21 have sealing lips, not shown. An electronic board 26 can be installed in the dry space 21. The electronic board 26 is fixed and locked in the dry space 21 by means of an elastic spring element, which is designed as a membrane spring 25 or as a simple piece of plastic with vibration-damping properties. A sensor 28 arranged on the electronic board 26, e.g., a Hall sensor, is arranged as a result in the dry space 21 at the wall 12 and in a fixed position in relation to the position of the impeller 4.

A battery 37 used to operate the electronic unit of the electronic board 26 is arranged in the dry space 21 (see FIG. 10). An overpressure protection means is provided for the case the battery 37 releases gas. This securing means is designed in a simple manner by providing a hole 30 in the cover 22, over which an adhesive label 31 is taped in the nonnal case. When a defined rated pressure, e.g., 1.5 bar, is exceeded in the dry space 21, the label 31 becomes detached. The adhesive properties of the adhesive label 31 are selected to be such that this function is guaranteed in the temperature range for which the flowmeter is intended. The adhesive label 31 is shaped such that it is water-tight and is sufficiently resistant to diffusion, so that humidity of the ambient air cannot enter the housing 2, so that the function of the electronic unit and the battery is not compromised. The adhesive label 31 may carry information, which is needed for the labeling of the flowmeter.

FIGS. 2, 11 and 12 show a special mounting of the essentially cylindrical outer surface 10 of the cartridge 3 at the inner surface 11 of the wall 12 of the housing 2.

When viewed in the longitudinal direction of the cartridge 3, there is a guide area 32 and a gap area 33 between the inner surface 11 of the wall 12 and the outer surface 10 of the cartridge 3, the gap area 33 being formed by the space 13, which is especially a cylindrical gap between the inner surface 11 and the outer surface 10.

The guide area 32 is shorter than the gap area 33 when viewed in the longitudinal direction (see FIG. 2). The length ofthe guide area 32 is, e.g., ⅛ to ½ of the length of the gap area 33.

The inner surface 11 of the wall 12 has a polygonal cross section in the guide area 32 and a hexagonal cross section in FIG. 12 (see FIG. 12). Essentially linear support zones 34, on which the outer surface 10 of the cartridge 3 is supported, are formed due to this polygonal, at least triangular shape. Between the support zones 34, there are intermediate zones 35 or corner zones 35, which are open toward the space 13 or the gap area 33, so that the water pressure acts on the outer surface 10 of the cartridge 3 in the area of the intermediate zones 35 as well.

A similarly acting support of the outer surface 10 of the cartridge 3 at the inner surface 11 of the wall 12 of the space 13 can also be achieved by providing humps, which form approximately punctiform support zones 34, in the guide area 32 at the outer surface 10 of the cartridge 3 and/or at the inner surface 11 of the wall 12.

The spacers 19, which are formed especially by locking hooks, are provided at the outer surface 10 of the cartridge 3 between the guide area 32 and the gap area 33. The locking hooks 19 cooperate with projections 36 of the inner surface 11 ofthe wall 12. It is achieved by means of these connection means that the cartridge 3 is held in the wall 12 such that it cannot separate under transportation conditions. The connection provided by the locking hooks 19 and the projections 36 does not lead to distortion in the longitudinal direction of the cartridge 3 during operation.

Due to the described arrangement of the cartridge 3 within the wall 12, the cartridge 3 is, on the one hand, mechanically extensively uncoupled from the wall 12, i.e., it lies free or freely floating, so that distortions which adversely affect the measurement results cannot occur in the case of structural tolerances or tolerances occurring due to the operation or forces or bending moments acting on the system from the outside. On the other hand or in spite of this, it is achieved that the cartridge 3 is securely guided within the wall 12 under all operating conditions such that tolerances of the guide, which could lead to a distortion of the measurement results, do not develop or exist.

While specific embodiments of the invention have been shown and described in detail to illustrate the application of the principles of the invention, it will be understood that the invention may be embodied otherwise without departing from such principles.

What is claimed is:

1. A flowmeter sensor for determining the flow of a medium, the flowmeter sensor comprising:
an impeller;
a cartridge, said impeller being installed in a cartridge, said cartridge being replaceably inserted into a water space of a housing or apparatus, the water space having connections to lines carrying the medium, said cartridge having an outer surface spaced apart from the inner surface of the water space forming the narrow space, said cartridge having a seal with a flange mounted in an expansion of the water space and the outer surface of the cartridge is subsequently supported at said flange by a guide surface of the inner surface of the water space, said guide surface being short compared with a length of said cartridge, said guide surface including linear or punctiform support zones with intermediate zones open toward said narrow space located between said support zones.

2. A flowmeter sensor in accordance with claim 1, wherein a conical surface of said flange is in sealing contact with a conical surface of said expansion.

3. A flowmeter sensor in accordance with claim 1, wherein said cartridge is formed of a transparent or partially transparent material.

4. A flowmeter sensor in accordance with claim 1, wherein said flange has a conical surface and a flexible sealing lip extends in a conicity of said expansion of the inner surface of the water space.

5. A flowmeter sensor in accordance with claim 1, wherein the cartridge has spacers at an outer surface of the cartridge.

6. A flowmeter sensor in accordance with claim 1, wherein the impeller is held rotatably in bearings inserted into a first and second bearing block.

7. A flowmeter sensor in accordance with claim 6, wherein said bearings contain graphite.

8. A flowmeter sensor in accordance with claim 1, wherein the impeller is magnetizable or contains magnetizable substance.

9. A flowmeter sensor in accordance with claim 6, wherein said first bearing block is inserted into said cartridge via webs and that said second bearing block is made in one piece with said cartridge.

10. A flowmeter sensor in accordance with claim 1, wherein the impeller contains materials that have a density deviating from that of the basic material, as a result of which, the axial forces of the impeller are compensated by weights.

11. A flowmeter sensor in accordance with claim 1, further comprising at least one dry space for accommodating the electronic board arranged at the flowmeter sensor.

12. A flowmeter sensor in accordance with claim 11, wherein an antenna connected to the electronic board is arranged in the dry space.

13. A flowmeter sensor in accordance with claim 11, further comprising a membrane spring or an elastic piece of plastic foam, whose spring forces act on the electronic board, said membrane spring being arranged in the cover and/or in the wall of the dry space.

14. A flowmeter sensor in accordance with claim 13, wherein the membrane spring or the piece of plastic is made in one piece with the housing or in the cover according to the twocomponent injection molding technique.

15. A flowmeter sensor in accordance with claim 5, further comprising spacers positioning the cartridge in the longitudinal direction arranged next to the guide area.

16. A flowmeter sensor in accordance with claim 1, wherein the inner surface of the water space has a polygonal, at least triangular shape in the guide area, wherein the outer surface ofthe cartridge is in an approximately linear contact with the inner surface of the water space between the intermediate zones forming corner zones to form the support zone.

17. A flowmeter sensor in accordance with claim 1, wherein said support zones comprise humps provided in the guide area at the inner surface of the water space and/or at the outer surface of the cartridge to form support zones.

18. A flowmeter sensor in accordance with claim 1, wherein the inner surface of the water space has a cylindrical shape adjacent to said guide area.

19. A flowmeter sensor in accordance with claim 1, wherein the overpressure protection means is provided at the cover.

20. A flowmeter sensor in accordance with claim 19, wherein an overpressure protection means is formed by an opening covered by the adhesive label.

21. A flowmeter sensor in accordance with claim 1, wherein the impeller is an axial impeller.
